(19) United States
(12) Patent Application Publication
(10) Pub. No.: US 2004/0077773 A1
(43) Pub. Date: Apr. 22, 2004

(54) Low viscosity, flexible, hydrolytically stable potting compounds

(76) Inventors: Manuel J. Tavares, Chester Township, NJ (US); Michael T. Phenis, Markleville, IN (US); Paul W. Hough, Indianapolis, IN (US)

Correspondence Address: Miles B. Dearth, Lord Corporation, 111 Lord Drive, PO Box 8012, Cary, NC, 27512-8012, US

(21) Appl. No.: 10/617,987

(22) Filed: Jul. 11, 2003

Related U.S. Application Data
(60) Provisional application No. 60/395,561, filed on Jul. 12, 2002.

(51) Int. Cl. C08K 3/00

(52) U.S. Cl. 524/507

(57) ABSTRACT

Novel liquid curable gelling material are disclosed and based on the reaction between a polyol-capped isocyanate and an adduct of an anhydride and a polyol. The liquid gelling material forms a gel characterized by both urethane and ester linkages. In a specific embodiment, the two part curable liquid potting composition comprises in part A, a hydroxyl capped polyisocyanate, and less than 1000 ppm of free isocyanate, and in part B, an anhydride adduct of polybutadiene comprising a polybutadiene segment. The preferred polybutadiene segment has a molecular weight of from 500 and 20,000. In a second embodiment, the 2-part curable liquid potting composition comprises in part A: a polybutaidene polyol capped polyisocyanate containing less than 1000 ppm of free isocyanate, and in part B an anhydride adduct of a polyol having a molecular weight of from 500 and 20,000.

This application claims benefit of U.S. Provisional Application No. 60/395,561, filed Jul. 12, 2002.

### FIELD OF THE INVENTION

The invention is directed to two-part liquid thermosetting compounds utilizing anhydride functional liquid rubber in reaction with polyol-capped polyisocyanate, and substantially free of reactive isocyanate groups.

### BACKGROUND OF THE INVENTION

Electrical and electronic components are encased or encapsulated using potting compounds. To meet the usual requirements, the mechanical properties must be maintained over a typical temperature range of −40° C. 105° C. Increased hydrolytic stability and reduced hardening after long term exposure to high humidity at 105° C. is critical to meet recent challenges in the industry.

A number of urethane materials from MDI (methylene di-p-phenylene isocyanate) and castor oil, and/or polybutadiene polyols have been implemented by pot on sand (POS) processing which comprises pouring mixed urethane over hot sand contained in the sensor container, or by vibrating hot sand into the urethane. The cured mixture provides environmental protection of the sensor element. Such material has a number of disadvantages. It is extremely difficult to process, and any processing error could result in a low reliability assembly. Even when correctly processed the assemblies do not pass rigorous environmental testing for water intrusion into the sensing element after salt spray or thermal cycling testing.

U.S. Pat. No. 4,348,307 discloses a castor oil based urethane system containing monofunctional alcohol, 2-octyidodecanol, which reduces the average hydroxyl functionality of the urethane system and serves to make the cured resin more flexible.

U.S. Pat. No. 5,185, 498 discloses encapsulation material comprising about 90 to 100 pbw of polyol and about 20 pbw of isocyanate, the polyol consists of at least 70% of hydroxy-polybutadiene . As an unfilled pottant, a hardness of 15 to 90 Shore A, an elongation of 50 to 300%, a tensile strength of 75 to 900 psi, and a glass transition temperature below −10° C. is obtained. The '498 patent teaches that materials with durometers less than 15 shore A will climb out of the can and do not provide sufficient support for the sensor element resulting in mechanical damage from thermal cycling and thrusting, while materials with hardness higher than 90 Shore A probably will damage the sensor and printed circuit board during thermal cycling. The potting compound of '498 contains free reactive isocyanate and poses a health and safety concern.

U.S. Pat. No. 5,608,208 (Delco) teaches low Shore A material derived from a combination of a major amount of polybutadiene polyol, and a minor amount of flexibilized polyol/polyepoxide epoxy reacted with a multifunctional isocyanate in an amount sufficient to achieve a stoichiometrically correct ratio. The preferred polymeric material suggested comprises: 85 to 100 parts by weight of a polyol of least 70 weight percent polybutadiene polyol mixture with up to 15 parts of a flexibilized polyol/polyepoxide epoxy novolak, and reacted with a multifunctional isocyanate in an amount sufficient to achieve a stoichiometrically correct ratio. The material has a hardness of about 15 to about 90 durometer Shore A. There is free isocyanate contained in the curable material raising health concerns in the work place.

In the same manner, Japanese Un-examined Patent Publication No. 85819/1982 (CA: 97 (20) 164709) discloses a urethane potting system for electronic devices, which comprises a mixture of castor oil and ethylene glycol esters of ricinoleic acid. Also, use of plasticizers such as dialkyl phthalates and other oils has been proposed. U.S. Pat. No. 3,714,110 discloses oil-extended urethane systems. It is well known that polybutadiene based polyols have higher molecular weights and less hydroxyl functionality than castor oil, and therefore form more flexible polyurethanes than castor oil does.

Although these systems possess desired low viscosity, they still have defects. The system comprising glycol esters of ricinoleate are known to exhibit a rather brittle property at low temperature. Of the various polyurethanes comprising reaction products of isocyanates and butadiene polyols that have good hydrolytic stability, often, after high temperature humidity exposure, these materials increase in hardness.

U.S. Pat. No. 4,008,197 and U.S. Pat. No. 4,166,258 disclose mineral oil extended polyurethane systems comprising castor oil and polybutadiene based polyols.

Japanese Un-examined Patent Publication No. 93717/1983 discloses a urethane composition comprising castor oil, polybutadiene based polyols and plasticizers.

U.S. Pat. No. 4,313,858 discloses a thermally-stable polyurethane system, comprising a polyisocyanate prepolymer, a polyol having pendant vinyl group, a drying oil and a peroxide catalyst.

U.S. Pat. No. 5,912,296 (Bridgestone) discloses a polymer gel composition which comprises 100 parts by weight of: a graft copolymer composition formed from the graft reaction of a maleate functionalized ethylene-alpha-olefin copolymer and a maleate functionalized polypropylene with an organic diamine grafting agent, and at least 30 parts by weight of an extender oil or a low molecular weight organic component. The gel compositions are noted to have super soft properties, heat resistance, and/or damping properties.

U.S. Pat. No. 6,350,800 (Bridgestone) discloses a soft polymeric gel composition comprising a polymer including an anhydride unit and an alkenyl unit, a crosslinking agent, a maleated polyalkylene, an extender, and an organic fatty acid is provided. The polymeric gel composition has superior high-temperature stability, mechanical strength, and moldability

Polymers formed from low molecular weight hydroxy terminated poly butadiene as tougheners and flexibilizers are taught in numerous patents relating to adhesives and coatings. For example, U.S. Pat. No. 3,910,992 and U.S. Pat. No. 3,925,330 describe reacting a carboxyl-terminated polybutadiene with glycidyl acrylate to obtain a liquid vinylidene-terminated polymer of the structure:

CH₂═C(R)—A—C(OH)(R)—CH₂—O—C(O)—(—B—)—C(O)—O—CH₂—C(OH)(R)—A—C(R)═CH₂

wherein A is preferably a bivalent radical of the structure —CH₂—O—C(O)—and B is a polybutadiene backbone. A tertiary amine is the preferred catalyst.

U.S. Pat. No. 3,897,514 discloses a process for curing hydroxy-terminated prepolymer to rubber that includes mixing a hydroxy-terminated polybutadiene prepolymer with a curing system comprising a cyclic anhydride and a di- or tri-functional epoxide. The curing catalyst is a chromium salt. The epoxides are diglycidyl ether epoxides, cyclic aliphatic diepoxides and triepoxides. The resulting product is cured and is a solid.

U.S. Pat. No. 5,629,379 discloses anhydride-hardened epoxy resin with polybutadiene-maleic anhydride adduct. Specifically, a toughened epoxy resin system having high temperature capabilities is prepared by curing blends of polyfunctiuonal epoxy resins, bicycloalkene dicarboxylic anhydride hardener, maleinized polybutadiene toughening agent, and supplemental hardener selected from the group consisting of aromatic tetracarboxylic dianhydrides and bismaelimides of aromatic diamines, and epoxy/anhydride accelerator.

U.S. Pat. No. 5,710,235 (Lord) discloses an olefinic-terminated polyalkadiene carboxylic ester and monoisocyanate-capped versions. The polyalkadiene is made by reacting a hydroxyl-terminated polyalkadiene with a saturated cyclic acid anhydride to form a carboxylic acid-terminated polyalkadiene, reacting the carboxylic acid-terminated polyalkadiene with an olefinic monoepoxide (e.g. glycidal methacrylate) to form an olefinic-terminated polyalkadiene, optionally reacting the olefinic-terminated polyalkadiene with a monoisocyanate.

U.S. Pat. No. 4,603, 188 discloses curable urethane composition which comprises a polyhydroxyl component and a polyisocyanate component, wherein the polyhydroxyl component comprises 80 to 10% by weight of an interesterification product (A) which is the reaction product of castor oil (al) and substantially non-hydroxyl-containing naturally occurring triglyceride oil (a2) and, optionally, low molecular weight polyol (a3) and 20 to 90% by weight of a polybutadiene based polyol (B). The composition has a sufficiently low viscosity to be easily handled and forms a polyurethane resin with excellent elongation and electrical properties. This curable polyurethane contains free, reactive isocyanate groups and poses a health concern.

U.S. Pat. No. 6,238,596 discloses crosslinkable thermal interface material of at least one maleinized liquid rubber cured to form a polyester by reaction with a hydrocarbyl polyol such as a liquid hydroxy terminated olefin rubber. Exemplary hydrocarbyl polyols reacted with the maleinized rubber include hydroxyl terminated polybutadiene, hydroxyl terminated epoxidized polybutadiene, hydroxyl terminated hydrogenated polyisoprene, and hydroxyl functional, poly (ethylene/butylene) polymers. This crosslinked polyester gel is devoid of urethane linkages and exhibits hydrolytic instability, in that the gel reverts under exposure to high temperatures and humidity after several days.

Flexible thermosetting resin potting materials, forming crosslinked gel compositions need the following characteristics: (1) a low viscosity so as to permit easy coil casting. In more particular, it should have a viscosity of 50 poises or less at the casting temperature in the case of vacuum or atmospheric pressure casting and a viscosity of 300 poises or less at the casting temperature in the case of pressure gelation casting. (2) It should have a long pot life. (3) It should no evolve volatile matters so that no void is developed in the course of heat curing. (4) It should exhibit good electrical and mechanical properties when cured.

Many voltage coils are exposed to harsh environments, particularly heat and humidity, such as operated in tunnels, under automotive hoods, in underground rooms, etc., providing exposure to high humidity atmospheres of 90% or more humidity over a long period while being subjected to a heavy mechanical or electric load. The cured product of the prior carboxylic acid anhydride-curing epoxy resin composition is known to undergo rapid deterioration of mechanical and electrical properties when it is in a state wetted by absorption of moisture or water. When a heavy load is mechanically or electrically applied in such a state, the system fails.

Molded coils formed by winding a conductor and casting and curing a thermosetting resin composition for casting high-voltage coils are apt to develop cracks in the insulating layer during the manufacture of the coils or when the coils are subjected to a heat cycle. With respect to thermosetting casting compounds, the thermal expansion coefficient (CLE) of the cured product is typically reduced by formulation with low CLE fillers so as to be similar to the thermal expansion coefficient of the conductor for avoiding the development of the cracks. However at severely high filler loadings decreases in strength after from 1 to 3 years exposure to high humidity atmosphere under heavy mechanical or electrical load. Therefore, the development of a resin composition for casting coils with high moisture resistance has been eagerly desired.

It would be industrially important to provide a reduced free isocyanate potting compound having hardness below Shore OO hardness to 100 Shore OO, which rapidly cures to a gel after several minutes, does not undergo significant hardening after heated, humidity aging, nor loses its gel structure after extended time under conditions at 105° C. and 15 p.s.i. .

### SUMMARY OF THE INVENTION

An object of this invention is to provide a novel liquid curable gelling material based on the reaction between a polyol-capped isocyanate and an adduct of an anhydride and a polybutadiene. The preferred polybutadiene is a hydroxyl terminated polybutadiene. The liquid gelling material forms a gel characterized by both urethane and ester linkages.

In a specific embodiment, the two part curable liquid potting composition comprises:

in part A: a hydroxyl capped polyisocyanate, and less than 1000 ppm of free isocyanate, and in part B, an anhydride adduct of polybutadiene of molecular weight of from 500 to 20,000.

In a second embodiment, the two part curable liquid potting composition comprises:

in part A: a polybutadiene polyol capped polyisocyanate, and less than 1000 ppm of free isocyanate, and in part B an anhydride adduct of a polyol having a molecular weight of from 500 to 20,000.

The proportion of polyol-capped isocyanate of at least 20 wt. % provides unexpected improved hydrolytic stability. At a polyol-capped isocyanate (urethane) content of at 40-70 wt. %, the gelled polymer is hydrolytically stable under severe conditions for extended periods. The reactants exhibit gel time controllable by the use of catalyst, at ambient conditions and provide a casting or potting compound, such as for encapsulating electric devices, as conformal coatings, including thermal interface layers, for printed circuit boards and sealing material for electrical and optical communication cables and cable connectors.

The invention provides a curable two-part gelling composition having the processing advantages typical of urethane systems of desirable low viscosity characteristics, good flexibility and electrical properties and has and low toxicity and can withstand soldering processing.

The curable gel is a two-part composition in a part A comprising a polyol-capped polyisocyanate containing less than 1000 ppm of free, reactive NCO groups. The preferred polyol cap is provided by a hydroxyl terminated liquid elastomer, such as the olefin elastomers like polyisoprene, polybutadiene. The polyol-capped polyisocyanate resin of part A contains from 0-1000 ppm, preferably 0-200 ppm of reactive isocyanate groups.

The invention provides material that can be formulated by mixing the polyol and anhydride functional components together in a stoichiometric ratio of fro 0.7 to about 1.5, in batch or with meter mix- dispensing equipment to any particular surface or potting container and cured at room temperature or elevated temperature to a solid, flexible gel. The invention can be formulated as a highly compliant, cured, tacky elastomeric film or sheet for a variety interface applications where it can be pre-applied, for example, on heat sinks, or in any other interface situations. The preferred usage is for castable potting of containerized electric or electronic devices.

### DETAILED DESCRIPTION OF THE PREFERRED EMBODIMENTS

Part A

Part A comprises a polyol capped polyisocyanate having low or no reactive NCO groups. This is an adduct and is distinguished from conventional isocyanate prepolymers formed using an excess of isocyanate, leaving typically 20-50% free reactive NCO groups. The polyol capped isocyanate is principally a partially crosslinked adduct formed in a manner so that all reactive NCO groups are capped. The partially crosslinked adduct is reducible in liquid vehicles such as non-reactive, reactive or solvent diluents. Chain extension can occur but to a limited extent. Any viscosity build is overcome by the presence of unreacted polyol. There is a limit on the proportion of free polyol so as to provide optimal hydrolytic stability in the proportion of urethane linkages to ester linkages. Therefore a stoichiometric excess of polyol: polyisocyanate is employed. Although, in principle, it is intended that all of the isocyanate functionality of the polyisocyanate be reacted, it should be understood that 100 percent complete reaction cannot always be attained, and therefore, trace amounts of less than 1000 ppm, preferably less than 200 ppm of unreacted isocyanate is within the scope of the invention. Alternatively, reacting “all” of the isocyanate for the purposes of the adduct used in Part A of the present invention may be defined as at least 99.99 percent complete reaction, preferably 100 percent. The isocyanates can be of low, high, or intermediate molecular weight and can be any of a wide variety of monomeric and polymeric organic polyisocyanates. The most preferred polyisocyanate is a liquid uretonimine-modified MDI. Typical aliphatic isocyanate compounds useful herein include hexamethylene diisocyanate, e.g. 2,2,4-trimethylhexamethylene-1,6-diisocyanate, and hexamethylene-1,6-diisocyanate (including dimers and trimers thereof), ethylene diisocyanate, trimethylene diisocyanate, dodecamethylene diisocyanate, hexamethylene diisocyanate, tetraethylene diisocyanate, pentamethylene diisocyanate, propylene-1,2-diisocyanate, 2,3-dimethyl tetramethylene diisocyanate, butylene-1,3-diisocyanate, butylene-1,3diisocyanate, 1,4-diisocyanato cyclohexane, ethylethylene diisocyanate and trimethylhexane diisocyanate, and the like.

Cycloaliphatic polyisocyanates include cyclobutane diisocyanate, cyclopentylene diisocyanate, e.g., cyclopentene-1,3-diisocyanate, cyclohexylene diisocyanate, e.g. methylcyclohexylene diisocyanate, dicyclohexylmethane diisocyanate, e.g. bis(4-isocyanatocyclohexyl)methane, and 1,4-cyclohexane diisocyanate, e.g. 1,4bis(isocyanatomethyl)cyclohexane.

Examples of aromatic polyisocyanates which can be used include but are not limited to 2,4-hexahydrotoluene diisocyanate, 2,6-hexahydrotoluene diisocyanate, 1,3-phenylene diisocyanate, 1,4-phenylene diisocyanate, 2,4toluene diisocyanate (TDI), 2,6-toluene diisocyanate, diphenyl methane-2,4′-diisocyanate(2,4′MDI), diphenyl methane-4,4′-diisocyanate (4,4′MDI), naphthalene-1,5-diisocyanate, triphenyl methane-4,4′,4″-triisocyanate, polymethylene polyphenylene polyisocyanates, isomers of bisphenylene diisocyanate, isomers of naphthylene diisocyanate, isomers of diphenylmethane diisocyanate, p-phenylene diisocyanate, 1-methyl phenylene-2,4-diisocyanate, naphthalene-1,4-diisocyanate, benzene-1,2,4triisocyanate, 4,4′-diphenylene propane diisocyanate, and mixtures thereof.

The term “liquid” is defined as a liquid at ambient temperature, or at elevated temperature, or a solution of polyisocyanate in a solvent for the polyisocyanate. Polyisocyanates containing from 10 to 50% reactive NCO groups which are liquid at ambient temperature, or are liquefied at up to about 70° C., or soluble in carriers or diluents are essential in the present invention. Numerous types of liquid isocyanates are described in, for example, U.S. Pat. Nos. 3,644,457, 3,883,571, 4,229,347, 4,055,548, 4,102,833,4,332,742, 4,448,904, 4,490,301, 4,490,302, 4,539,156, 4,539,158, 4,883,909, 4,442,235 and 4,910,333, as well as mixtures of polyol adducted polyisocyanate with MDI polymeric or modified MDI are described in U.S. Pat. Nos. 4,031,026, 4,261,852, 4,321,333, 5,240,635 and 5,246,977.

A useful liquid polyisocyanate is prepared through the reaction with hydroxyl functional materials catalyzed using an organometallic or tertiary amine. Useful hydroxy compounds are aliphatic alcohols containing about 1 to 36 and preferably 4 to 16 carbon atoms. Non-limiting examples of aliphatic alcohols are cycloaliphatic alcohols, aliphatic alcohols containing aromatic groups, aliphatic alcohols containing groups that do not react with isocyanates e.g., ether groups and halogens such as bromine and chlorine. Specific non-limiting examples of aliphatic alcohols are 2-methyl-1-propanol, cetylalcohol, cyclohexanol, 2-methoxy-ethanol, and 2-bromoethanol. Branched aliphatic alcohols having relatively molecular weights up to 150, are most preferred.

Exemplary liquid adducts of isocyanates compounds include a reaction product of solid 4,4′-and/or 2,4′-diphenylmethane diisocyanate with a branched aliphatic dihydroxy compound in a molar ratio of 0.1 to 0.3 mol of dihydroxy compound per mol of diisocyanate. Another exemplary liquid MDI-based compound is a reaction product of MDI with mixtures of monoalcohol, poly-1,2-propylene ether glycols and a triol. Another exemplary liquid polyisocyanate is the reaction product of an alcohol or thiol having an average functionality of from about 1.5 to about 4 and an average equivalent weight of at least about 500 with at least 2 equivalents per hydroxyl and/or thiol equivalent of an organic polyisocyanate wherein about 20% of the initially formed urethane or thiourethane groups are converted to allophanate and/or thioallophanate groups. Allophanate based on 4.,4′ and the 2,4′ isomers of diphenylmethane diisocyanate is one useful example. It is possible to form liquid polyisocyanates from the reaction products of 4,4′-diphenylmethane diisocyanate with one or more monohydric alcohols having 4 to 16 carbon atoms at an NCO:OH equivalent ratio of 5:1 to 8.5:1, and a temperature of up to 160° C. to form urethane groups, and during or subsequent to urethane formation, converting the urethane groups in the presence of a catalyst to allophanate groups. Blended liquid isocyanate adducts are also useful. A specific example liquid polyisocyanate composition having an NCO group content of from 15 to 30% and which contains less than 90% by weight of diphenylmethane diisocyanate, comprises a blend of:

(A) 10 to 90% by weight based on 100% by weight of (A) and (B), of an MDI adduct having an NCO group content of 15 to 30%, and

(B) 10 to 90% by weight based on 100% by weight of (A) and (B), of an allophanate-modified MDI, having an NCO group content of 12 to 32.5%.

Polyisocyanates or their adducts react instantaneously with the polyol component to form the hydroxy-capped polyisocyanate. Some crosslinking typically occurs. SO long as the adduct remains liquid and flowable A stoichiometric ratio of polyol: to polyisocyanate for forming the polyol-capped polyisocyanate is from 1 to 20, preferably from 5 to 15, more preferably from 8 to 12. Unreacted polyol can be present, or additional polyol can be added to the polyol-capped isocyanate reaction product forming part A. Essentially all of the reactive isocyanate groups on the polyisocyanate are capped with the polyol. Any polyol is suitable for capping the polyisocyanate. Mixtures of short and long chain polyols can be used for capping the polyisocyante forming part A.

Short chain polyols are generally defined as having hydroxyl functionality of 2 to 20, more preferably 2 to 4 and a molecular weight of from 90 to 800 as suitable for capping the polyisocyanate of Part A. Exemplary short chain secondary diols having functionality of 2, include diols having at least 4 carbon atoms, e.g., 2,3-butane diol, 2,5-hexane diol, 2,6-heptane diol, propoxylated neopentyl glycol. The short chain polyols having functionality greater than two can be triols, e.g. trimethylol propane, tetra-ols, e.g. pentaerythritol, and the like, and can also include secondary polyalkylene ether triols, tetra-ols, and the like. The polyalkylene ether triols can be prepared by reacting cyclic ethers such as alkylene oxides (e.g. propylene oxide, butylene oxide, etc.), tetrahydrofuran, or dioxolane with trifunctional hydroxy compounds such as trimethylol propane, 1,2,6-hexane triol, glycerol, and the like in ring-opening reactions well known in the art. Typical polyalkylene ether triols include polypropylene ether triol, polybutylene ether triol, polyethylene ether triol, polytetramethylene ether triol, and polyethylene propylene ether triol, with trimethylol propane polyproxylate being most preferred

Long chain polyols having functionality of 2 to 20, preferably 2 to 6 and a molecular weight of from 2000 to 100,000 are suitable for capping the polyisocyanate of Part A. Long chain polyols include the broad classes of polyether, polyester, polycaprolactone, polycarbonates, acrylic polyols, and polybutadiene polyols, hydroxy terminated olefin elastomers, and the like. The functionality of the long chain secondary polyol is not critical. The functionality of long chain secondary polyols can range from 1.6 to about 4. The long chain polyol used herein are predominantly secondary polyols, preferentially polyether polyols capped or terminated with a secondary hydroxyl group through addition of, for example, propylene oxide, and most preferably containing solely polyoxypropylene groups. A weight amount no more than 25% of primary hydroxy groups can be included such as polyols terminated with ethylene oxide in the amount from 1 to 25 weight percent. Preferably the amount of primary polyol is no more than 15%, and more preferably no more than 5%.

Included as suitable polyols are polyether polyols, for example, polyoxyethylene glycol, polyoxypropylene glycol, polyoxybutylene glycol, polytetramethylene glycol, block copolymers, for example combinations of polyoxypropylene and polyoxyethylene poly-1,2-oxybutylene and polyoxyethylene polyols, poly-1,4-tetramethylene and polyoxyethylene polyols, and copolymer polyols prepared from blends or sequential addition of two or more alkylene oxides. The polyalkylene polyether polyols may be prepared by any known process such as those prepared by polymerization of epoxides such as ethylene oxide, propylene oxide, butylene oxide, tetrahydrofuran, styrene oxide, or epichlorohydrin either alone or by chemical addition to other materials such as ethylene glycol, propylene glycol, trimethylol propane, 4,4′-dihydroxy diphenyl propane, and the like. Sucrose polyethers also may be used. Polyether polyols are available globally from Bayer, BASF, and Dow.

Alternative to the polyether polyols are polyester polyols such as those formed by the reaction of lactones or carboxylic acids with multi-functional hydroxy compounds. The carboxylic acid-based polyester polyols of the invention can be prepared according to methods known in the art by reacting carboxylic acids such as succinic acid, adipic acid, suberic acid, azelaic acid, sebacic acid, phthalic acid, isophthalic acid, or terephthalic acid with multifunctional hydroxy compounds such as ethylene glycol, diethylene glycol, 1,4butane diol, 1,3-propane diol, 1,6-hexane diol, trimethylol propane, glycerol, erythritol, pentaerythritol, poly(ethylene oxide) diol, poly(ethylene oxide/propylene oxide) diol, and poly(tetramethylene oxide) diol in various combinations well known in the art. Presently preferred carboxylic acid-based polyester polyols include 1,6-hexane diol phthalate polyester diol, 1,6-hexane diol adipate diol, and 1,6-hexane diol ethylene glycol adipate diol. Polyester polyols are commercially available globally from Bayer, Stepan, and Ruco.

Lactone-based polyester polyols are prepared according to methods known in the art by reacting a lactone such as caprolactone with a multifunctional hydroxy compound as defined immediately above. A particularly preferred lactone-based polyester polyol, which is also preferred over the carboxylic acid-based polyester polyols in general, is a polycaprolactone triol prepared from the reaction of caprolactone and trimethylol propane. Lactone-based polyols are commercially available from Union Carbide and Solvay Interox.

The terms polyalkadiene and polybutadiene are used interchangeably and refer to any liquid homopolymer or copolymer comprising a polymerizate of a diene monomer. The terms “hydroxy-terminated polybutadiene”, “polyhydroxy polybutadiene” and “polybutadiene polyol” are used interchangeably and refer to polyalkadiene polymers containing statistically more than 1 hydroxyl group per molecule. Polybutadiene polyols are the preferred starting material for the polyol capped urethane prepolymer employed in Part A. The terms “capped” is inclusive of capping and chain extension. In the preferred embodiments an excess of polyol over isocyanate is present. On an equivalent weight basis, the ratio of equivalents of polyol to isocyanate ranges preferably from 2:1 to 20:1, preferably 5:1 to 15:1, and most preferably 8:1 to 12:1.

The most preferred polyol for capping the polyisocyanate of Part A is a liquid polybutadiene polyol. Any liquid hydroxy terminated polybutadiene can be used as the starting material. Suitable hydroxy-terminated polybutadiene is described in U.S. Pat. No.3,652,520 beginning at column 3, line 64, U.S. Pat. No. 3,808,281 and 5,153,287, all incorporated herein by reference. The anionic polymerization method is described in U.S. Pat. Nos. 5,376,745, 5,391,663, 5,393,843, 5,405,911, and 5,416,168 which are incorporated by reference herein. The polydiene diols have the structure X(OH)_{b} wherein X is the polyalkadiene residue and b is at least 1.2, and preferably is 1.2 to 3, more preferably 1.6 to 2.4 per polymer molecule. The number average molecular weight of preferred hydroxy terminated polyalkadiene is typically from 500 to 20,000, more preferably from 1000 to 10,000. The polybutadiene based polyols include homopolymers of butadiene, copolymers of butadiene and their hydrogenated derivatives. Hydrogenated polybutadiene diols are preferred and these preferably have 1,4-addition between 30% and 70% and of comparatively lower viscosity. A particularly preferred precursor is hydroxyl-terminated polybutadiene. A typical polybutadiene polyol is available from as Liquiflex® from Petroflex. Hydrogenated polybutadiene polyols are available ex. Mitsubishi Chemical Industries Ltd. under the trademark “POLYTAIL”, and from Elf-Atochem under the tradenames “R45HT” and “R20LM”.

The preferred polyol capped isocyanate of Part A is made by reacting a stoichiometric excess of polyol to polyisocyanate. Any liquid polyol may be used. The preferred polyol is a hydroxy-terminated polybutadiene. Optional non-reactive diluents, catalyst, and other conventional adjuvants are typically included in part A.

Part B

Anhydride modified adducts are widely available in various grades. The most preferred anhydride adduct is maleinized polybutadiene. The adduct is readily prepared by conventional methods by reacting polybutadiene liquid polymers with an anhydride. One method involves the Ene reaction. Al alternative anhydride adduct material is made by coupling a hydroxyl terminated polybutaidiene with anhydride. The anhydride type is not critical. Exemplary anhydrides utilized for reaction with hydroxy terminated polybutadiene include, without limitation, phthalic anhydride, succinic anhydride, maleic anhydride, trimellitic anhydride, hexahydrophthalic anhydride, chlorinated anhydrides such as chlorendic anhydride and tetrachlorophthalic anhydride, methyltetrahydrophthalic anhydride, itaconic anhydride, pyromellitic dianhydride, benzophenonetetracarboxylic dianhydride, and cyclopentanetetracarboxylic dianhydride. Preferred are those anhydrides, such as phthalic anhydride and succinic anhydride, which are comparatively more soluble in hydroxy terminated polybutadiene at relatively low temperatures, i.e. 120° C. and below. Preferred anhydrides allow for the use of lower temperature equipment and, therefore, makes processing easier and less expensive. Mixtures of different anhydrides may also be used.

The adducting reaction of anhydride and polybutadiene polyol can be performed in a standard reaction flask in an inert atmosphere, such as a nitrogen atmosphere, at approximately 100° C. -160° C., and. preferably 100° C.-120° C., for approximately 1 to 4 hours, wherein essentially all of the anhydride is reacted. Lower temperatures tend to lower the viscosity of the product. An amine catalyst, such as methylguanadine can be used. However, such catalysts may retard curing of parts A and B and are, therefore, not preferred. Suitable carboxy modified polyalkadiene adducts are taught in U.S. Pat. No. 5,587,433 (Sartomer). Maleic grafted polybutadienes are commercially available from Sartomer (Atofina) as RICON® MA. Various grades include Ricon®130MA-6, -8, -10, -13 and 20, 131 MA-5, -10, -17, and -20. Brookfiel viscosities range from 1000 to 150,000 cps at 25° C.

Curing the Two-part Material

The two-part liquid thermosetting composition is optionally cured with or without heat, with out without catalyst or accelerator. In the presence of selected accelerators, the gelled product forms at room temperature in the presence of a cure accelerator. Conventional accelerators include such compounds as amines such as trimethylamine, triethylamine, didecylmethylamine, tetramethylbutanediamine and triethylenediamine; oxygenated amines such as dimethylaminoethanol, dimethylaminopentanol, tris(dimethylaminomethyl)phenol, and N-methylmorpholine; ethylenediamine, propanediamine, butanediamine, pentanediamine, hexanediamine, isomers of the named amines, 1,2- and 1,4-diaminocyclohexane, diethylene-triamine, triethylene-tetramine, tetraethylene-pentamine, N-aminoethyl-3-aminopropyltrialkoxysilane, triamino-functional propyltrialkoxysilane, piperazine, aminoethylpiperazine, di-aminoethyl-piperazine, xylylenediamine, isophoronediamine, 3,3′ -dimethyl-4,4′-diaminodicyclohexylmethane, 4,4′-diaminocylohexylmethane, 4,4′-diamino-diphenylmethane, 1,4-diaminobenzanilide. The accelerator can be used neat, or in a form adsorbed onto zeolite supports, such as is known and also taught in U.S. Pat. No. 5,792,816.

Other accelerators of interest are quaternary ammonium salts such as cetyltrimethylammonium bromide, cetyltrimethylammonium chloride, cetyltrimethylammonium iodide, dodecyltrimethylammonium bromide, dodecyltrimethylammonium chloride, dodecyltrimethylammonium iodide, benzyldimethyltetradecylammonium chloride, benzyldimethyltetradecylammonium bromide, allyldodecyltrimethylammonium bromide, benzyldimethylstearylammonium bromide, stearyltrimethylammonium chloride, and benzyldimethyltetradecylammonium acetylate; imidazoles such as 2-methylimidazole, 2-ethylimidazole, 2undecylimidazole, 2-heptadecylimidazole, 2-methyl-4-ethylimidazole, 1-butylimidazole, 1-propyl-2-methylimidazole, 1-benzyl-2-methylimidazole, 1-cyanoethyl-2-phenylimidazole, 1-cyanoethyl-2-methylimidazole, 1-cyanoethyl2-undecylimidazole, 1-azine-2-methylimidazole, and 1-azine-2-undecylimidazole; microencapsulated amines and imidazoles; metal salts of amines and imidazoles with zinc octanoate and cobalt octanoate; 1,8-diazabicyclo (5,4,0)-undecene-7, N-methylpiperazine, tetramethylbutylquanidine; amine tetraphenylborates such as triethylammonium tetraphenylborate, 2-ethyl-4-methylimidazole tetraphenylborate, and 1,8-diazabicyclo(5,4,0)-undecene-7-tetraphenylborate; triphenylphosphine, triphenylphosphonium tetraphenylborate, aluminumtrialkyl acetoacetate, aluminum trisacetylacetoacetate, aluminum alcoholates, aluminum acylates, sodium alcoholates, boron trifluoride, complexes of boron trifluoride with amines or imidazoles, diphenyliodonium salt, aliphatic sulfonium salts; amine imides obtained by reacting a monocarboxylic acid alkyl ester with hydrazines an monoepoxy compounds; and metallic soaps such as salts of cobalt, manganese, iron, etc. of octylic acid and naphthenic acid. Particularly useful among them are quaternary ammonium salts, metal salts of amines and imidazoles with octoates of zinc, cobalt, etc., amine tetraphenylborates, complexes of boron trifluoride with amines or imidazoles, diphenyliodonium salt of HasF₆, aliphatic sulfonium salts, amine imide, and microcapsules of amines or imidazoles. Some of these are latent curing catalysts, which are relatively stable at ordinary temperature and provide useful open time, but readily initiate curing reactions when brought to high temperature. The accelerators are used at levels ranging from 0.001% by weight to 2.0%, preferably in a proportion of 0.1%-10% by weight relative to the weight of reactive components in part A and B, and depending upon the desired gel time.

Diluent.

Diluents are optional and provide for control of viscosity in the invention. Example diluents include, non-hydroxyl-containing naturally occurring oils, such as triglyceride oil exemplified by corn oil, cotton seed oil, peanut oil, olive oil, palm oil, palm kernel oil, sunflower seed oil, coconut oil, safflower oil, poppy seed oil, tea seed oil, kapok oil, rice bran oil, grain sorghum oil, rapeseed oil, linseed oil, soybean oil, perilla oil, hempseed oil, wheat germ oil, rubber seed oil, tung oil, oiticica oil, whale oil, California sardine oil, Japanese sardine oil, menhaden oil, herring oil, fish liver oil, lard, and tallows. These oils have a preferred hydroxyl value of less than 5.0.

Optional Additives

It is frequently desirable to include other conventional additives known in the art to the curable compositions of the present application. Heat stabilizers, UV stabilizers, UV absorbers, antioxidants, particulate and fibrous fillers or reinforcing agents, reinforcing resins, pigments or colorants or tinting agents, fragrances, and the like are examples of some well known optional additives. Specific examples of useful antioxidants and stabilizers include 2-(2′-hydroxy-5′-methylphenyl)benzotriazole, nickel di-butyl-di-thiocarbamate, zinc di-butyl-di-thiocarbamate, tris(nonylphenyl)phosphite, 2,6-di-t-butyl-4-methylphenol, and the like. Exemplary conventional fillers and pigments include silica, carbon black, titanium dioxide, iron oxide, and the like. These compounding ingredients are incorporated in suitable amounts depending upon the contemplated use of the product, preferably in the range of 1-350 parts of additives or compounding ingredients per 100 parts of the cured polymer composition.

Some fillers act as reinforcing fillers. Most reinforcing materials are inorganic or organic products of high molecular weight. Various examples include glass fibers, asbestos, boron fibers, carbon and graphite fibers, whiskers, quartz and silica fibers, ceramic fibers, metal fibers, natural organic fibers, and synthetic organic fibers. Thermal conductive carbon fibers, for example pitch-based carbon fiber, and vapor grown carbon fiber can be included to increase the thermal conductivity of the material. Vapor Grown carbon fiber is available from Applied Sciences, Inc., Cedarville, Ohio. Other elastomers and resins are also useful to enhance specific properties like damping properties, adhesion, and processability.

In some filled embodiments of the present invention, where dispersion of fillers, improved adhesion, for coupling of solid material components, or of multiple matrices, and/or for coupling to substrates is desirable or needed, surface active agents are usually employed. Various mono- and di-functional surface-active agents, including coupling types may be included. These agents are not specifically limited so long as enhanced wetting, dispersion, adhesion, and/or coupling occurs in the liquid or cured solid state. Often, use is made of surface active agents for control of rheology, such as decreasing the viscosity, releasing entrapped air, and for improved resistance to cracking and resistance to moisture. Examples of such surface active agents include silane type surface active agents such as gamma.-chloropropyltrimethoxysilane, vinyltrichlorosilane, vinyltriethoxysilane, vinyltrimethoxysilane, vinyltris(.beta.-methoxyethoxy)silane, gamma.-methacryloxypropyltrimethoxysilane, .beta.-(3,4-epoxycyclohexyl)ethyltrimethoxysilane, .gamma. -glycidoxypropyltrimethoxysilane,.gamma.-mercaptopropyltrimethoxysilane, .gamma.-aminopropyltrimethoxysilane, and gamma.-ureidopropyltriethoxysilane; titanate type surface active agents such as isopropyl isostearoyl titanate, isopropyl trioctanonyl titanate, isopropyl methacryloyl isostearoyl titanate, isopropyl tridodecyl titanate, isopropyl isostearoyl diacryl titanate, isopropyl tris(dioctyl phosphate) titanate, isopropyl tricumylphenyl titanate, isopropyl tris(dioctyl pyrophosphate) titanate, isopropyl tris(n-amino-ethylaminoethyl)titanate, tetraisopropylbis(dioctylphosphite) titanate, tetraoctylbis(didodecyl phosphite) titanate, tetra(2,2-diallyloxymethyl-1-butyl)bis(ditridecyl) phosphite titanate, diisostearoyl ethylene titanate, and bis(dioctyl pyrophosphate) ethylene titanate; aluminum-based surface active agents such as ethylacetoacetatealuminum dusopropylate and aluminum tris(ethylacetoacetate); zirconium-based surface active agents, etc. Preferred among them are .gamma.-glycidoxypropyltrimethoxysilane, .beta.-(3,4-epoxycyclohexyl)ethyltrimethoxysilane,.gamma.-mercaptopropyltrimethoxysilane,.gamma.-aminopropyltriethoxysilane, N-.beta.-(aminoethyl)-.gamma.-aminopro pyltrimethoxysilane, isopropyl isostearoyl titanate, isopropyl trioctanoyl titanate, ethylacetoacetatealuminum diisopropylate, and aluminum tris(ethylacetoacetate), the aforesaid list being understood as obviously not exhaustive of the known surface active agents. The surface active agents may also be used as a mixture of two or more thereof. Particularly preferred is to use together both (A) a monofunctional surface active agent such as isopropyl isostearoyl titanate, isopropyl trioctanolyl titanate and the like to attain low viscosity and improve resistance to cracking and (B) a multifunctional surface active agent such as gamma-glycidoxypropyltrimethoxysilane, .beta.-(3,4-epoxycyclohexyl)ethyltrimethoxysilane,.gamma.-mercaptopropyltrimethoxysilane,.gamma.-aminopropyltriethoxysilane, N-.beta.-(aminoethyl)-.gamma.-aminopro pyltrimethoxysilane, and the like to improve moisture resistance and mechanical strength.

The surface active agent may be either added after being applied to a filler in advance, or later added to the liquid part containing the filler, or may alternately added by using the above two methods together. From the viewpoint of enhancing wetting between the thermosetting resin composition and the filler, it is preferable either to treat the filler with the surface active agent in advance to compounding of the resin composition or to treat a portion of the filler with the surface active agent beforehand and later add the treated filler to the resin composition already containing the other portion of the filler.

As one embodiment, a thermal conducting interface is provided by the inclusion of thermally conductive fillers, such as silver, copper, aluminum, and alloys thereof; boron nitride, aluminum nitride, silver coated copper, silver coated aluminum and carbon fiber in known effective amounts with the two-part liquid thermosetting composition. It may also desirable where bond-line thickness needs controlling to include incompressible substantially spherical inorganic or organic particles to limit the compressibility of the material in interface applications, i.e. to limit or control the film thickness. Glass, quartz, ceramic blends of silica and alumiosilicates, rigid thermoplastics, like styrenics, polyamides, polysulfones, in bead configuation, and the like, are available in various particle diameter ranges.

Some Uses

The two-part liquid compounds are useful alone for encapsulating coils, molded transformers, flyback transformers, fluorescent lamp transformers, various electric motors for washing machines, starter motors for automobiles, encapsulant for integrated circuit boards, electronic chip assemblies, thermally conductive interfaces such as die attach, lid-die attachments, and other uses for adhesives for electric and electronic parts such as bushing, TAB, COB, etc., general purpose adhesives, and composite materials such as FRP, and laminate sheets. Additionally the flexible, two-part thermosetting compositions can be incorporated into other two-part thermosetting resin systems such as unsaturated polyester-based resin compositions, polyurethane-based resin compositions, silicone-based resin compositions, acid anhydride-curing epoxy resin compositions, amine-curing epoxy resin compositions, thiol-curing epoxy resin compositions, phenol-curing epoxy resin, phenol novolaks-curing epoxy resin, cresol novolaks-curing epoxy resin, catalyst alone-curing epoxy resin compositions, isocyanate-curing epoxy resin compositions, maleimide-based resin compositions, etc. Preferred among them from the viewpoints of electric property and thermal resistance are acid anhydride-curing epoxy resin compositions, maleimide-based resin compositions and isocyanate-curing epoxy resin compositions.

Uses as Flexibilizer for Other Thermosetting Compounds—Epoxy Resins

The two-part liquid thermosetting composition can be used together with any of the aforementioned thermosetting materials which by themselves are considered to form hard or rigid cured materials. Preferred thermosetting materials for combination with the two-part thermosetting composition according to the invention are epoxidized materials. The multifunctional epoxy resins optionally used in the present invention are not particularly limited. Examples of such epoxy resins include bifunctional epoxy resins such as diglycidyl ether of bisphenol A, diglycidyl ether of bisphenol F, diglycidyl ether of bisphenol AF, diglycidyl ether of bisphenol AD, diglycidyl ether of hydrogenated bisphenol A, diglycidyl ether of 2,2-(4-hydroxyphenyl)nonadecane, 4,4′-bis(2,3-epoxypropyl) diphenyl ether, 3,4-epoxycyclohexylmethyl-(3,4-epoxy)cyclohexanecarboxylate, 4-(1,2-epoxypropyl)-1,2-epoxycyclohexane, 2-(3,4-epoxy)cyclohexyl-5,5-spiro-( 3,4-epoxy)-cyclohexane-m-dioxane, 3,4-epoxy-6-methylcyclohexylmethyl-4-epoxy-6-methylcyclohexanecarboxylate, butadiene-modified epoxy resin, urethanemodified epoxy resin, thiol-modified epoxy resin, diglycidyl ether of diethylene glycol, diglycidyl ether of triethylene glycol, diglycidyl ether of polyethylene glycol, diglycidyl ether of polypropylene glycol, diglycidyl ether of 1,4-butanediol, diglycidyl ether of neopentyl glycol, diglycidyl ether of the adduct of bisphenol A and propylene oxide, and diglycidyl ether of the adduct of bisphenol A and ethylene oxide; and trifunctional epoxy resins such as tris[p-(2,3-epoxypropoxy)phenyl]methane and 1,1,3-tris[p-(2,3-epoxypropoxy)phenyl]butane. Further, mention may be made of multifunctional epoxy resins including glycidylamines such as tetraglycidyidiaminodiphenylmethane, triglycidyl-p-aminophenol, triglycidyl-m-aminophenol, diglycidylamine, tetraglycidyl-m-xylenediamine and tetraglycidylbisaminomethylcyclohexane, phenol novolak type epoxy resin and cresol novolak type epoxy resin. Multifunctional epoxy resins obtained by reacting epichlorohydrin with a mixture of at least two polyhydric phenols selected from (a) bis(4-hydroxyphenyl)methane, (b) bis(4-hydroxyphenyl)ethane, (c) bis(4-hydroxyphenyl)propane, (d) tris(4-hydroxyphenyl)alkane, and (e) tetrakis(4-hydroxyphenyl)alkane can also be used because they have a low viscosity and good workability before being cured and exhibit a high thermal resistance after being cured. Examples of the tris(4-hydroxyphenyl)alkane include tris(4-hydroxyphenyl)methane, tris(4-hydroxyphenyl)ethane, tris(4-hydroxyphenyl)propane, tris(4-hydroxyphenyl)butane, tris(4-hydroxyphenyl)hexane, tris(4-hydroxyphenyl)heptane, tris(4-hydroxyphenyl)octane and tris(4-hydroxyphenyl)nonane. Tris(4-hydroxyphenyl)alkane derivatives such as tris(4-hydroxydimethylphenyl)methane, etc. may also be used. Examples of the tetrakis(4-hydroxyphenyl)alkane include tetrakis(4-hydroxyphenyl)methane, tetrakis(4-hydroxyphenyl)ethane, tetrakis(4-hydroxyphenyl)propane, tetrakis(4-hydroxyphenyl)butane, tetrakis(4-hydroxyphenyl)hexane, tetrakis(4-hydroxyphenyl)heptane, tetrakis(4-hydroxyphenyl)octane, and tetrakis(4-hydroxyphenyl)nonane. Tetrakis(4-hydroxyphenyl)alkane derivatives such as tetrakis(4-hydroxymethylphenyl)methane, etc. may also be used. Useful among them from the viewpoint of viscosity are diglycidyl ether of bisphenol A, diglycidyl ether of bisphenol F, diglycidyl ether of bisphenol AF, diglycidyl ether of bisphenol AD, tetraglycidyldiaminodiphenylmethane, triglycidyl-p-aminophenol, triglycidyl-m-aminophenol, diglycidylamine, tetraglycidyl-m-xylylenediamine and tetraglycidylbisaminomethylcyclohexane. In particular, diglycidyl ether of bisphenol F and diglycidyl ether of bisphenol AF are useful from the viewpoints of viscosity and resistance to cracking. The multifunctional epoxy resins may also be used in combination of two or more thereof. Further, reactive diluents, such as monofunctional epoxy resins, e.g., butyl glycidyl ether, styrene oxide, phenyl glycidyl ether, and alkyl glycidyl ether may be added together with the multifunctional epoxy resins and 2-part liquid thermosetting composition to maintain a desirable viscosity in a range considered pourable at ambient conditions or as heated, if necessary. However, the amount of a monofunctional epoxy resin added must be limited to a small value because though it has the effect of lowering the viscosity it tends to lower thermal resistance.

Other acid anhydrides may be incorporated as a co-curative in blend embodiments. Other co-curing agents, if used in the present invention are not particularly limited. Conventional acid anhydrides are co-curatives, and include such compounds as methylhexahydrophthalic anhydride, hexahydrophthalic anhydride, methyltetrahydrophthalic anhydride, tetrahydrophthalic anhydride, nadic anhydride, methylnadic anhydride, dodecylsuccinic anhydride, succinic anhydride, octadecylsuccinic anhydride, maleic anhydride, benzophenonetetracarboxylic acid anhydride, ethylene glycol bis(anhydrotrimellitate), glycerol tris(anhydrotrimellitate), and the like. These anhydrides may be used each alone or in a combination of two or more thereof. The two-part liquid thermosetting compositon s can be blended with maleimide-based resin compositions. The maleimide compositions are not specifically limited so long as they are resin compositions containing maleimide. Examples of such maleimide-based resin compositions include those described in Japanese Patent Kokai (Laid Open) No. 60-184509 and Japanese Patent Kokoku (Post-Exam. Publication) Nos. 58-17532, 57-28416, 57-37604, 56-50900, 55-39242, 51-29760, 51-35520, 50-9840, 49-290080, and 49-1960. Preferred among them from the viewpoints of viscosity and thermal resistance are bismaleimide- and/or monomaleimide-containing acid anhydride-curing epoxy resin composition and allylphenol-curing maleimidebased resin composition.

A different type of flexibilizer can be combined with the two-part liquid thermosetting composition. A combination of such other flexibilizer together with a hard-forming thermosetting material is also envisioned. Known conventional flexibilizing agents are widely available, and not specifically limited in comdbination with the two-part liquid thermosetting composition so long as it is a flexibility imparting agent capable of imparting flexibility, toughness and adhesiveness. Examples of such conventional flexibilizing agents include diglycidyl ether of linoleic acid dimer, diglycidyl ether of polyethylene glycol, diglycidyl ether of polypropylene glycol, diglycidyl ether of alkylene oxide adduct of bisphenol A, urethane-modified epoxy resin, polybutadiene-modified epoxy resin, polyols such as polyethylene glycol, polypropylene glycol, and hydroxyl-terminated polyester, polybutadiene, alkylene oxide adduct of bisphenol A, polythiol, urethane prepolymer, polycarboxyl compounds, phenoxy resin, polycaprolactone, and the like. Compounds as caprolactones are low in viscosity and co-cure with epoxy resins. The amount of the flexibilizing agent added should be limited to the necessary minimum because the addition of the agent tends to lower the thermal resistance of the two-part liquid thermosetting composition in accordance with the invention.

### Examples

A polyol capped isocyanate masterbatch is prepared from:

| Component | Eq. Wt. | Amount (grams) |
|---|---|---|
| (1.) Poly-Bd* | 1176.5 | 1885.2 |
| (2.) MDI** | 143.3 | 114.79 |

*Hydroxy terminated polybutadiene;
**uretonimine modified 4,4′-diphenylmethane diisocyanate that has a % NCO value of 29.3

Procedure

In a clean jacketed vessel (1.) is added. Under agitation (2.) is added. The mixture is agitated for 15-20 minutes keeping the batch under 100° C. If the batch exceeds 100° C. then it is cooled until the temperature is 80° C.

Part A

The following Part A is made by combining:

| Component | Wt. percent | Amount (grams) |
|---|---|---|
| Masterbatch | 41.0 | 1244.31 |
| Catalyst² | 1.72 | 51.59 |
| soya oil | 56.15 | 1704.09 |

²tris(dimethylaminopropyl)hexahydrotriazine catalyst available from Air Products.

Part B

The following mixture is made:

| Component | Wt. percent | Amount (grams) |
|---|---|---|
| Anhydride - Pbd^{#} | 37.28 | 1118.62 |
| Soya Oil | 62.71 | 1881.38 |

^{#}Rican ® 131 MA 10

A polyol-capped urethane pre-polymer part A is produced in a mixture polyol and an isocyanate. The isocyanate in this pre-polymer can be made in a master batch. The polyol caps all free isocyanate groups. This mixture of polyol with a catalyst, polyol and a non-reactive diluent to produce the final resin portion of the material. There is no reaction or reaction by-products resulting from the mixture of the master batch and the remaining constituents of the resin.

The Part B side, or hardener is a mixture of a non-reactive diluent and adducted polybutadiene -anhydride. There are no reactions or reaction by products from this mixture.

Testing: The following well known tests can illustrate the properties of useful potting compounds according to the invention.

Viscosity A and B and initial mixture viscosity;

Specific Gravity A, B and Mixture;

Hardness: Shore OO and penetration;

Texture: A Texture Analyzer, made by “Texture Technologies Corp.”, model TA-XT2i is suitable;

Gel Time (Sunshine Gelometer 25° C., 50° C. and 150° C.);

Weight Loss: 175° C. and 200° C. for 168 hours;

Weight Gain, water 24 hours at room temperature;

Hydrolytic stability at 105° C., 15 psi for 168 hours;

Tensile adhesion test;

Tensile elongation tes;t

Hardness at 150° C. for 168 hours;

Glass Transition Temperature;

Coefficient of Thermal Expansion;

Dielectric Constant;

Dissipation Factor;

Dielectric Strength;

Volume Resistivity;

| | | | Penetration | | | |
|---|---|---|---|---|---|---|
| | Mixed Vis. | Penetration | after 130° C. | | Hardness | *Humidity |
| Example | 25° C. | mm @ 150 g | 168 hours | Tg (C.) | Shore OO | Testing |
| Control 1¹ | 200 | 26.3 | 20.8 | −125 | N/A | Survived |
| | | | | | | w/ |
| | | | | | | 40% increas |
| Control 2² | 1500 | 4.7 | 2.8⁷ | −75 | 25 | Survived |
| | | | | | | w/ |
| | | | | | | 37% increas |
| Control³ | 770 | 4.1 | .6⁷ | −90 | 16 | Reverted |
| Example 1⁴ | 4400 | 3.4 | .4⁷ | −90 | 40 | Survived |
| Example 2⁵ | 1800 | 3.6 | .4⁷ | −90 | 45 | Survived |
| ⁶P. D. | 5000 | 20.3 | 4.1⁷ | −72.9 | 3 | Did not |
| George | | | | | | survive |
| Pedigree | | | | | | |
| #22/23 | | | | | | |

*Humidity testing is characterized as the Hydrolytic stability of the material @ 15 psi for 168 hours @ 105° C. Stable materials will not breakdown under the test stresses and maintain its gel structure. An unstable material will revert back to liquid.
¹SC-300M is a commercial silicone gel available from Thermoset.
²UR-312 is a commercially urethane gel available from Thermoset.
³Control 3 is a reaction product of adducted maleic anhydride Pbd reacted with a hydroxyl terminated pre-polymer absent urethane linkages.
⁴Example 1 is adducted maleic anhydride Pbd reacted with a hydroxyl terminated pre-polymer and contains urethane linkage according to the invention.
⁵Example 2 is adducted maleic anhydride Pbd reacted with a hydroxyl terminated pre-polymer and contains urethane linkage according to the invention.
⁶P. D. George is a competitive “isocyanate free” gel. It has no urethane linkages.
⁷The material surface hardened.

The formulation described herein is a general encapsulant, two component, low viscosity, low modulus, potting compound. The cured product is a flexible material that will serve as an environmental barrier that will utilized protect delicate circuit boards. The material was designed as an alternative to expensive silicone compounds as well as an alternative to urethane/isocyanate type systems.

Further Anhydride Adducts

In an inert atmosphere 631 g of a polybutadiene (available from ElfAtochem under the tradename “R45HT”), having 2.4-2.6 terminal OH groups per molecule (0.54 eq of hydroxyl) and a number average molecular weight of 2800, and 59.9 g (0.40 moles) of phthalic anhydride are reacted in the presence of 0.6 g (0.004 moles) of 1,8-diazabicyclo[5.4.0]undec-7-ene at 85° C. until the acid number drops to 0.58 meq/g.

Anhydride Adduct:

In an inert atmosphere blanket 631 g of a polybutadiene (Elf-Atochem “R45HT”), having 2.4-2.6 terminal OH groups per molecule and an number average molecular weight of 2800, and 90.1 g (0.27 moles) of alkenyl succinic anhydride are reacted in the presence of 0.6 g of 1,8-diazabicyclo[5.4.0]undec-7-ene at 85° C. until the acid number drops to 0.37 meq/g.

We claim:

1. A two part curable liquid potting composition comprising:
in part A: hydroxyl capped polyisocyanate, said part A containing less than 1000 ppm of free isocyanate
and in part B an anhydride adduct of polybutadiene comprising a polybutadiene segment having a molecular weight of from 500 and 20,000.

2. The composition of claim 1, wherein the polybutadiene is hydroxyl terminated and has from 1.9 to 2 hydroxyl groups per molecule.

3. The composition of claim 1, wherein the polybutadiene has a number average molecular weight between 1,000 and 10,000.

4. The composition of claim 1, wherein the polyisocyanate is 4,4′-diphenylmethane diisocyanate.

5. A two part curable liquid potting composition comprising:
in part A: a polyol capped polyisocyanate, said part A containing less than 1000 ppm of free isocyanate, and wherein said polyol is a polybutadiene polyol, and
in part B an anhydride adduct of a polyol wherein said polyol has a molecular weight of from 500 and 20,000.
